(19) United States
(12) Patent Application Publication
(10) Pub. No.: US 2007/0225628 A1
(43) Pub. Date: Sep. 27, 2007

(54) Massage Attachment for Motor-Driven Foot Care Apparatus

(75) Inventor: Klaus Hafemann, Essen (DE)

Correspondence Address: RICK MARTIN;PATENT LAW OFFICES OF RICK MARTIN, PC, 416 COFFMAN STREET, LONGMONT, CO, 80501, US

(73) Assignee: WIK FAR EAST, LTD, Hong Kong (CN)

(21) Appl. No.: 11/470,086

(22) Filed: Sep. 5, 2006

Related U.S. Application Data
(63) Continuation-in-part of application No. 10/346,127, filed on Jan. 16, 2003, now abandoned.

(30) Foreign Application Priority Data
Jan. 19, 2002 (DE) 202 00790.1

(51) Int. Cl. A61H 7/00

(52) U.S. Cl. 601/134

(57) ABSTRACT

A massage attachment for a motor-driven foot care apparatus is disclosed. The massage attachment has a coupling piece attached torsion tight onto a driving shaft of the foot care apparatus. A central core bar is connected to the coupling piece and receives the rotational movement of the driving shaft directly. Spherical massage elements are rotatably mounted on plug-in axles extending in a direction from the central core bar that drives the axles. The massage attachment has filler elements between the massage elements filling a portion of the interspace between the massage elements. The massage elements define the maximum diameter of the massage attachment such that the massage elements extend beyond the outer top surface of the filler element in the direction of its axis of rotation. The massage elements allow a user to utilize the different rotation behavior of the massage elements during rotation of the massage attachment.

### CROSS REFERENCE APPLICATIONS

This application is a continuation in part of application Ser. No. 10/346,127 filed on Jan. 16, 2003, which claims priority from German application no. 202 00790.1 filed Jan. 19, 2002.

### FIELD OF INVENTION

The present invention relates to a massage attachment for a motor-driven foot care apparatus with a coupling piece to attach onto a driving shaft of the foot care apparatus, as well as several movably disposed massage elements with spherical physical appearance.

### BACKGROUND OF THE INVENTION

Foot care devices that are part of a foot tub and foot massage device are known in the art. The tub bottom of the foot bath can be made to vibrate for massaging the soles of the feet. The foot tub is divided into two areas by a ridge for receiving one foot in each area. A motor-driven foot care apparatus is integrated in the ridge. The rotationally driven driving shaft of the foot care apparatus projects at the top from the ridge and carries a first coupling piece. Different attachments for foot care and/or foot massage can be attached onto the driving shaft with its end-terminal coupling piece.

A known massage attachment has a coupling piece which makes a torsion-tight connection between the driving shaft and the massage attachment. The massage attachment is developed at the top as a ball bearing cage with several spherical massage elements, or massage balls. The massage balls are disposed in one plane such that they are movable. The massage elements themselves remain stationary and can rotate in all directions in their cage. The massage balls project a portion of their surface from the top of the cage. This means that the effective massage depth is defined by the projection of the massage balls from the upper cage shell. Such a foot care apparatus is known for example from DE 295 02 720 U1.

Such a massage attachment conventionally comprises several massage rollers, which are distributed uniformly over the surface of the massage attachment. The individual massage balls project by only a few millimeters from the upper shell of the ball bearing cage. During the operation the massage attachment rotates and a foot massage occurs due to the rotational movement of the massage balls. Under unfavorable conditions it is possible for skin to be pulled into the bearing gap between the surface of a massage ball and the upper cage shell through the rotational movement of the massage balls. This can be painful; it is, in any event, undesirable.

Building on this discussed prior art the invention therefore addresses the problem of further developing a massage attachment such that the disadvantages entailed in prior art are avoided.

### SUMMARY OF THE INVENTION

The primary aspect of the present invention is to provide a massage attachment with a reduced chance of skin trapping.

Other aspects of this invention will appear from the following description and appended claims, reference being made to the accompanying drawings forming a part of this specification wherein like reference characters designate corresponding parts in the several views.

This problem is solved by having the spherical massage elements each rotatably supported on an axle extending in a direction comprising a vectorially radial component.

In the case of the present invention the spherical massage elements are not supported, as is the case in prior art, in a ball bearing cage and consequently over its surface, but rather on an axle. The axle on which at least one spherical massage element is disposed has in its extension a vectorially radial component. Such an axle can extend, for example, radially with respect to the provided axis of rotation.

In the present invention the massage attachments individual spherical massage elements are supported by a shaft insert into which the axle of the massage attachment engages and which is thus supported internally. This means that the distance of the effective surface of the massage elements from the bearing is spaced so far apart that there is no danger that skin of the foot to be massaged being near the bearing. Moreover, in the present massage attachment, even at high massage pressures at which foot regions could potentially approach up to the axle, there is no danger that skin can be pulled into the movement gap between the rotating massage element and the axle, since a gripping effect is not given, as is the case within prior art.

A further advantage of such a bearing of the employed massage elements is that the massage elements can be developed to be much larger than in prior art. In particular, the massage elements can be developed such that they extend beyond the support margin so that it is also possible to massage the foot utilizing the different rotational behaviors of different areas of the massage elements during a rotation of the massage attachment.

The axles for the mounting of the individual massage elements can be disposed emanating from a central core bar. This central core bar serves simultaneously as a filler element for filling out a portion of the interspace between the individual massage elements. Filler elements can further be disposed between massage elements in each instance. The height of the filler elements also determines the effective massage depth.

It is advantageous to use plug-in axles on which the individual spherical massage elements are supported. The free end of the plug-in axle is located within the massage elements, so that the massage elements project beyond the free end of the plug-in axle.

### BRIEF DESCRIPTION OF THE DRAWINGS

FIG. 1 is a schematic side view of a massage attachment.

FIG. 2 is a top view of the massage attachment of FIG. 1.

FIG. 3 is a section through the massage attachment along line A-B of FIG. 2.

Before explaining the disclosed embodiment of the present invention in detail, it is to be understood that the invention is not limited in its application to the details of the particular arrangement shown, since the invention is capable of other embodiments. Also, the terminology used herein is for the purpose of description and not of limitation.

### DETAILED DESCRIPTION OF THE DRAWINGS

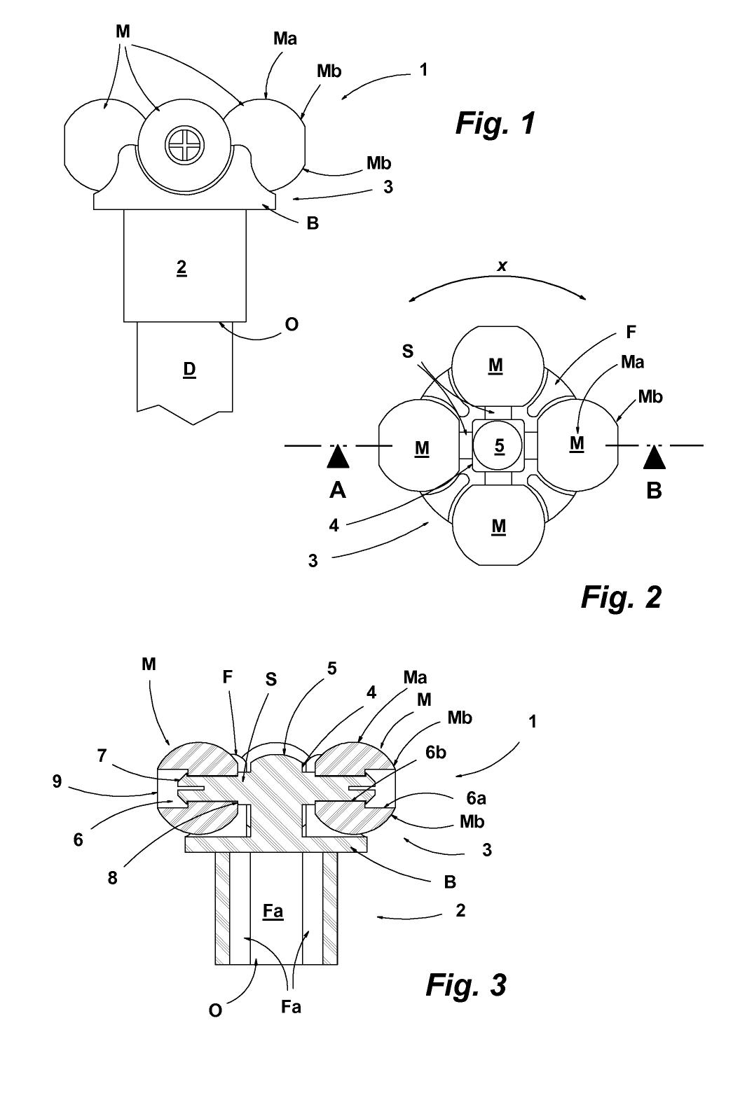

Referring first to FIG. 1, a massage attachment 1 has a coupling piece 2, with which the massage attachment 1 can be attached torsion-tight onto the free end of a driving shaft D of a foot care apparatus. In order to achieve this, the coupling piece 2 has a hexagonal shaped opening O with several faces Fa in FIG. 3. The free end of the driving shaft D is introduced into opening O. The outer shape of the free end of the driving shaft D is shaped in a complementary manner to the opening on the inside of the opening O. Thus the massage attachment 1 may easily be mounted in a torsion tight manner to the driving shaft D and also be easily dismounted therefrom without needing any tools or further connection means. The massage attachment 1 is set into rotation during operation of the foot care apparatus as shown by arrow X in FIG. 2. The rotation can be in a single direction or oscillatory.

A roller support 3 is positioned on top of the coupling piece 2, and supports the massage rollers M, as shown in FIG. 1. In the embodiment example depicted, there are four massage rollers M, more or less massage rollers M are possible. The roller support 3, as shown in FIG. 2, has a base B, a central core bar 4 with a surface 5 curved at the top side.

Core bar 4 has four plug-in axles S placed such that they project radially outwardly, in the depicted example. The number of plug-in axles would match the number of massage rollers M. The plug-in axles S serve for mounting and bearing the individual massage rollers M. Consequently the massage rollers M are rotatable about their plug-in axles S. Between two massage rollers M can be disposed a filler element F as a portion of the roller support 3. Through the filler elements F the massage rollers M are largely enclosed in their lower region, as shown in FIG. 1. The base B is part of the filler elements F. The outside surface of the filler elements F follows the geometry of the massage rollers M leaving only a small gap. The filler elements F and the massage rollers M form a surface-geometry to prevent skin from being pulled into the gap between the massage rollers M and the filler element F. As can seen in FIG. 1, the filler elements F do not extend in height beyond the center of the axles bearing the massage rollers M. A person may thus enjoy a massage without worrying that skin could be squeezed during the massage, as would be encountered with prior art devices if the foot to be massaged is placed in an incorrect location on the massage device.

In the depicted embodiment example the massage rollers M are mounted form-fittingly on a given plug-in axle S, as is shown in FIG. 3. To allow mounting the massage rollers M on a plug-in axles S each massage roller M has a through channel 6 with two areas, 6a and 6b, with two different diameters.

The plug-in axles S have at the ends a mushroom-like thickening Sa and a narrowing directed outwardly. The plug-in axles S have slotted development on their ends forming fingers 7. These fingers 7 can be moved toward one another such that the mushroom-like thickening Sa can be guided through the portion of the through channel 6 with the smaller diameter of a massage roller M, allowing the massage roller M to be mounted on plug-in axles S.

The length of the section having the smaller diameter 6b of the through channel 6 of the massage rollers M corresponds to the bearing length provided by a plug-in axle S, which, in the direction toward the central core bar 4, is delimited by a stop 8. Consequently each massage roller M on the bearing segment of the plug-in axles S is fixed in the axial direction of the plug-in axle S. As can be seen in FIG. 2 the plug-in axles S do not extend radially out of the massage rollers M. The front opening 9 of the through channel 6 can be closed with a cap, not shown.

The coupling piece 2 of the massage attachment 1 is developed hexagonally at the inside to rotationally engage the free end of a driving shaft. If the end of the driving shaft had a different shape, then the inside of coupling piece 2 would be shaped accordingly.

A special characteristic of the embodiment example depicted in the Figures is that the individual massage rollers M are developed to extend beyond the margin of the roller support 3. This allows that not only the upper sides Ma of the massage rollers M to be utilized for massaging, but also their sections Mb located radial to the axis of rotation of the massage attachment 1. Thus it is possible that different portions Ma, Mb of the massage rollers M are used for different massage effects or treatments respectively, without the need to change the attachment. This is not possible with prior art massage attachments as only the top surfaces of the massage elements can be used. When a foot is resting on top of the massage attachment the sole of the foot will be in contact with the top sides Ma of the massage rollers M. The rotational movement of the massage attachment 1 and the massage rollers M will cause the massage rollers M to roll on the sole of the foot. The massaging pressure is controlled by the person resting his foot on the massage attachment.

If the foot is held in a position so that sole contacts the rotating massage attachment 1 more on surface Mb, in a radial direction of the massage rollers M, this rolling effect is more of a scrubbing massaging. If the foot is held with his sole more or less parallel to the axis of rotation of the massage attachment 1 on surfaces Mb only a scrubbing effect will be encountered. This scrubbing effect may be used for cleaning purposes or to peel off an outer skin layer. As body part to be massaged may be rested on the different surfaces of the massage rollers, the massage elements allow a user to utilize the different rotational behavior of the massage rollers M during rotation of the massage attachment 1. The extension of the massage rollers M with respect to the base B allows the user to enjoy different massaging effects with the massage attachment 1. The exposition of the massage rollers surfaces Ma, Mb to be used for massaging a foot in a chosen location, and the filler elements F and the design and arrangement of the plug-in axles S, bearing the massage rollers M, not exiting the massage rollers M on the side opposite to the central core bar 4 allow both surfaces Ma and Mb to be used for massaging a body part.

In the depicted embodiment example the massage rollers M are supported centrally. Nevertheless, it is also possible to provide that the plug-in axles are born eccentrically in the massage rollers or in other spherical massage elements in order to make possible in this way during the massaging also a vertical massage movement of individual massage elements.

Although the present invention has been described with reference to preferred embodiments, numerous modifications and variations can be made and still the result will come within the scope of the invention. No limitation with respect to the specific embodiments disclosed herein is intended or should be inferred. Each apparatus embodiment described herein has numerous equivalents.

### LIST OF REFERENCE SYMBOLS

1 Massage attachment
2 Coupling piece
3 Roller support
4 Core bar
5 Surface
6 Through channel
   6a, 6b subsections of Through Channel
7 Finger
8 Stop
9 Opening
B Base
D Driving shaft
F Filler element
Fa Faces
M Massage roller
Ma, Mb Surfaces of massage rollers
O Opening
S Plug-in axle

I claim:

1. Massage attachment for a motor-driven foot care apparatus having a rotational direction of movement, said massage attachment comprising:
a coupling piece attached torsion tight onto a driving shaft of the foot care apparatus;
a central core bar connected to the coupling piece and receiving the rotational movement of the driving shaft directly;
a plurality of massage elements, each with a generally spherical physical appearance;
the spherical massage elements each being rotatably mounted on an axle extending in a direction from the central core bar, the central core bar thus driving the plug-in axles bearing the massage elements;
one or more filler elements placed between the massage elements for filling out a portion of an interspace between the individual massage elements;
wherein the maximum diameter of the massage attachment is defined the massage elements such that the massage elements extend beyond the outer top surface of the filler element in the direction of the axis of rotation of the massage attachment and in the radial directions to the axis of rotation of the massage attachment; and
the massage elements thus functioning to allow a user to utilize the different rotation behavior or the massage elements during rotation of the massage attachment.

2. The massage attachment as claimed in claim 1, wherein the axles for the bearing of the massage elements are disposed such that they extend radially with respect to the provided rotational direction of the massage attachment driven by the foot care apparatus.

3. The massage attachment as claimed in claim 3, wherein the spherical massage elements in the direction of the extension of their particular plug-in axle project beyond a free end of the plug-in axle.

4. The massage attachment as claimed in one of claims 1 or 2, wherein the massage attachment comprises at least four spherical massage elements.

5. Motor-driven foot care apparatus with a driving shaft for having a rotational direction of movement and a massage attachment, said massage attachment comprising:
a coupling piece with which the massage attachment may be attached torsion tight onto the driving shaft of the foot care apparatus;
a central core bar connected to the coupling piece and receiving the rotational movement of the driving shaft directly;
a plurality of massage elements, each with a generally spherical physical appearance; and
the spherical massage elements each being rotatably mounted on an axle extending in a direction from the central core bar, the central core bar thus driving the plug-in axles bearing the massage elements;
one or more filler elements placed between the massage elements for filling out a portion of the interspace between the individual massage elements; and
wherein the maximum diameter of the massage attachment is defined the massage elements such that the massage elements extend beyond the outer top surface of the filler element in the direction of the axis of rotation of the massage attachment and in the radial directions to the axis of rotation of the massage attachment;
the massage elements thus functioning to allow a user to utilize the different rotation behavior or the massage elements during rotation of the massage attachment.

6. The foot care apparatus as claimed in claim 5, wherein the axles for the bearing of the massage elements are disposed such that they extend radially with respect to the provided rotational direction of the massage attachment driven by the foot care apparatus.

7. The foot care apparatus as claimed in claim 6, wherein the spherical massage elements in the direction of the extension of their particular plug-in axle project beyond a free end of the plug-in axle.

8. The foot care apparatus as claimed in one of claims 6 or 2, wherein the massage attachment comprises at least four spherical massage elements.
